(19) United States
(12) Patent Application Publication
(10) Pub. No.: US 2014/0089142 A1
(43) Pub. Date: Mar. 27, 2014

(54) SYSTEM AND METHOD FOR AGGREGATING INFORMATION ASSOCIATING A USER WITH A PRODUCT

(71) Applicant: John O. Jackovin, Johnston, IA (US)

(72) Inventor: John O. Jackovin, Johnston, IA (US)

(21) Appl. No.: 13/625,217

(22) Filed: Sep. 24, 2012

(51) Int. Cl. G06Q 30/00

(52) U.S. Cl. 705/26.61

(57) ABSTRACT

A system for scanning products and retrieving information associated therewith is described. The system includes a mobile device provided with a scanner. A user scans a product with the mobile device, and the mobile device transmits the scanned information to a server via a network. The system returns information about the product from the server to the mobile device and presents the users with options to obtain additional information about the product. The system also stores information associating the user with the product and allows the user to post information relating to the product to a social media profile.

### TECHNICAL FIELD

The disclosed embodiments relate generally to product information retrieval and, in particular, to the use of hand-held scanning devices to request and retrieve specific product information.

### BACKGROUND

Scanners are well known devices to identify a product and retrieve certain information, such as price relating to that product. Most scanners are relatively large devices used by merchants at the point of sale to rapidly retrieve price information for multiple products prior to sale.

It is also known in the art to provide hand-held scanners. Merchants use also use these scanners at the point of sale to read universal product code (UPC) symbols that may be on large, bulky or otherwise difficult to manipulate products. Merchants also use hand-held scanners to take real time inventory of products on store shelves. It is known in the art to use scanners to retrieve product information. Consumers may use scanners to retrieve information regarding products purchased. An example of such a scanner is discussed in U.S. Pat. No. 7,440,993. While such devices do provide consumers the ability to retrieve information regarding products purchased, the scanners may be difficult to use for products which have not yet been purchased, products which are not contained in the server associated with the scanner, and for searching general product categories associated with the particular product.

Additionally, such devices are not designed to allow a consumer to share and trade information relating to the product with the user's friends. Such information may include comments, reviews, photographs, etc. One goal of some embodiments of this invention is to allow users to retrieve information about various types of products and to share this information with friends. Thus, there is a need for a portable scanner system with increased product information and the ability to share this information.

### SUMMARY OF THE DISCLOSED SUBJECT MATTER

The deficiencies described above are overcome by the disclosed implementation of a system and method for aggregating information associating a user with a product. The system includes a mobile device and a server. The mobile device can include a scanning device and means to establish communication with the server either directly or across a network.

Information regarding a product is scanned or otherwise input into the memory of the mobile device and forwarded to the server. The server collects information relating to the product from a database and returns the information to the mobile device. Once the mobile device receives the product information, the user may use the product information to obtain additional information on the product, annotate the information and/or share the information with friends others via email, SMS, MMS, or social network.

### BRIEF DESCRIPTION OF THE DRAWINGS

The present invention will now be described, by way of example, with reference to the accompanying drawings in which:

FIG. 1 illustrates a component diagram of components included in a typical implementation of the system in the context of a typical operating environment;

FIG. 2 illustrates a flow diagram showing steps typically performed by the system to input initial product information into the database associated with the server;

FIG. 3 illustrates a flow diagram showing steps typically performed by the system to receive input instructions from a user;

FIG. 4 illustrates a flow diagram showing steps typically performed by the system to return product information to a user;

FIG. 5 illustrates a flow diagram showing steps typically performed by the system to add user annotations to the product information;

FIG. 6 illustrates a flow diagram showing steps typically performed by the system to provide a user with information in response to user-selected criteria;

FIG. 7 illustrates a display diagram showing a display of a user profile interface in accordance with one embodiment;

FIG. 8 illustrates a display diagram showing a display of a timeline screen in accordance with one embodiment;

FIG. 9 illustrates a display diagram showing a display of a product screen in accordance with one embodiment;

FIG. 10 illustrates a display diagram showing a display of a scanning screen in accordance with one embodiment;

FIG. 11 illustrates a display diagram showing a display of a confirmation screen in accordance with one embodiment;

FIG. 12 illustrates a display diagram showing a display of a annotation screen in accordance with one embodiment;

FIG. 13 illustrates a display diagram showing a display of a friends screen in accordance with one embodiment;

FIG. 14 illustrates a display diagram showing a display of a popular screen in accordance with one embodiment; and

FIG. 15 illustrates a display diagram showing a display of a recent screen in accordance with one embodiment.

### DETAILED DESCRIPTION OF THE DRAWINGS

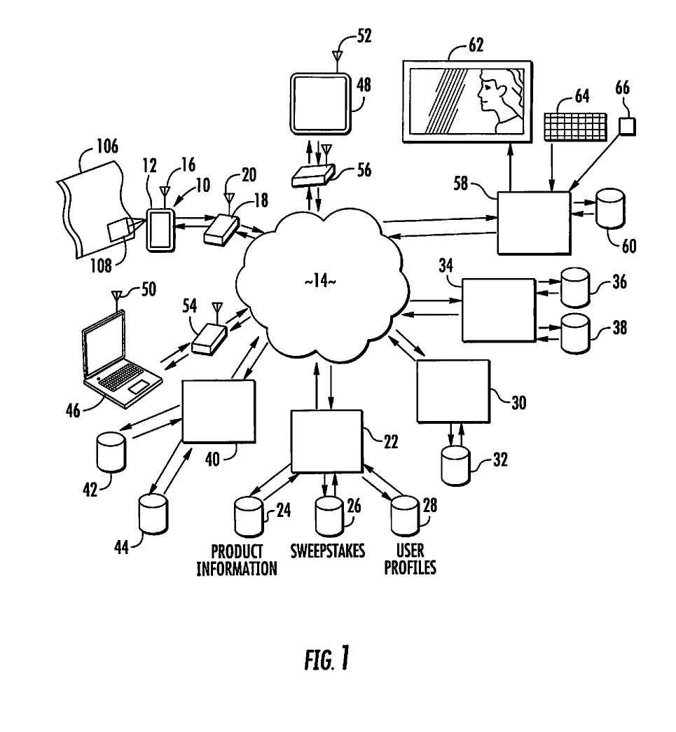

FIG. 1 is a component diagram of components included in a typical implementation of the system in the context of a typical operating environment. The system aggregates information associating a user with a product. As used herein, the term “product,” comprises anything that can be purchased, including, but not limited to, tangible goods, intangible goods, and services. As illustrated, the operating environment includes one or more mobile devices (10) provided with a scanner (12). The mobile device (10) may be a computer having a memory containing computer executable instructions for processing information. The mobile device (10) may be a telephone, a smart phone, a cellular phone, a portable audio player, or any other information-transmitting device. The scanner (12) may be of any type known in the art, but is preferably combined in a mobile computing platform provided with an integrated camera, such as an iPhone® manufactured by Apple, Inc. The scanner may be any type of device capable of optically interpreting a visual code, such as a bar code, a QR code, a product label, words on a sign, or any visual code known in the art. Preferably, the mobile device (10) is integrated with the scanner (12). In other embodiments, the mobile device (10) and scanner (12) may be separate devices, wired to one another or coupled wirelessly in a manner such as that known in the art.

The mobile device (10) is coupled to a network (14) either using a direct wire or wireless connection. The network (14) may be a local network, but is preferably a global communications network. The mobile device (10) is provided with an antenna (16) to connect wirelessly with a base station (18) that, in turn, is provided with an antenna (20) and is direct wired to the network (14). Also coupled to the network (14), either by a direct wire or wireless connection, is a server (22). The server (22) may be a computer having a memory containing computer executable instructions for processing information received from the mobile device (10). The server (22) is coupled to one or more databases (24), (26) and (28).

Coupled to the network (14) is a second server, such as a merchant server (30) coupled to a merchant database (32). A search engine server (34) is coupled to the network (14) and one or more databases (36) and (38). Also coupled to the network (14) is a product information aggregator server (40), such as a shopping aggregator, coupled to one or more databases (42) and (44). Other mobile devices, such as a laptop (46) and tablet computer (48) are coupled to the network via antennae (50) and (52) and base stations (54) and (56). A desktop computer (58) is coupled to the network (14) and a database (60). Also coupled to the desktop computer (58) is a display (62) and input devices such as a keyboard (64) and mouse (66). The foregoing devices may be coupled to the network (14) and to one another by any means known in the art and may be operable in accordance with known commercial transaction communication protocols.

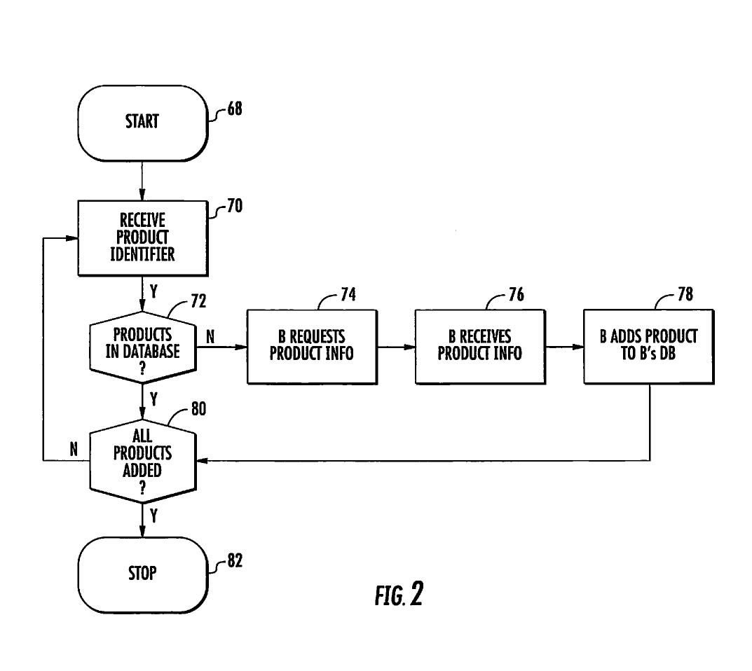

FIG. 2 is a flow diagram showing the steps typically performed by the system to initially enter products into the database (24) associated with the server (22). (FIGS. 1-2). The process begins at (68), with the first step (70) being the server (22) receiving a first product identifier. The product identifier can be the product name, a product code, or any identifier allowing the server to check to see if a product is contained in the database (24). In the next step (72), the server (22) checks the product information database (24) to determine if product information associated with the product identifier is already stored in the database (24). If the product information is not in the database (24), the next step (74) is for the server (22) to request the product information from another source. The server (22) may request the product information across the network (14) from a second server, such as the search engine server (34), the merchant server (30), the product information aggregator server (40), or through any other means known in the art. Stored on the second server is information associated with the product. The information associated with the product may be information relating directly to the product, such as price or warranty information, or may be information relating indirectly to the product, such as the address of a database, or another server containing information relating to the product.

Next (76), the server (22) receives the product information from the outside source and proceeds to (78) where the server (22) adds the product information to the product information database (24). Once the product information is in the database, the process moves to (80), to determine if all products desired to be placed into the database (24) are in the database (24). If all of the products are not in the database (24), the process returns to Step (70) to receive the next product identifier. Once the server (22) determines there are no more product identifiers to consider, this routine finishes at (82). While in the preferred embodiment the server (22) runs this routine to determine if all of the product information has been entered into the database (24), the product information may be added directly to the database (24) through any known means.

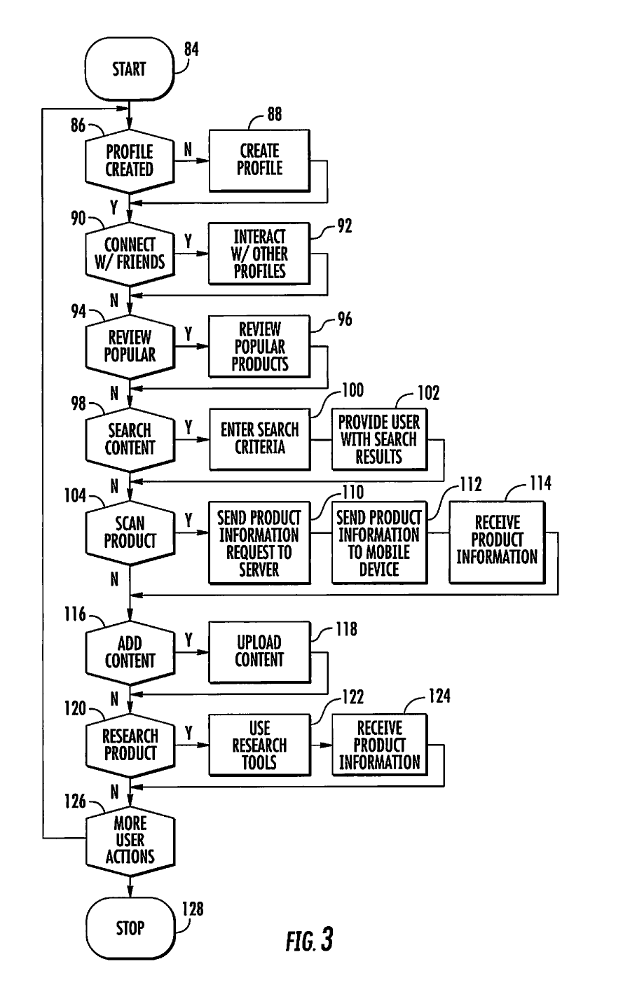

FIG. 3 is a flow diagram showing the steps typically performed by the system in response to various requests by a user. The process begins at (84) with the first step (86) being determining if a user profile has been created. If no user profile has been created, the system prompts the user to create (88) a profile that is stored in the database (28) coupled to the server (22). The user profile may be created by any known means and may include any desired fields. Once a user profile is created, the system provides the user with the opportunity (90) to connect with friends. If the user desires to connect with friends, the process moves to (92), where the server (22) provides the user with the opportunity to interact with the profiles of other users in a manner such as known in other social media platforms. The user may also, if desired, provide the server (22) access to a user's contact list, stored on the mobile device (10), a server, or elsewhere. If the server (22) has access to the user's contact list, the server (22) provides the user with the opportunity to share information regarding products with the user's contacts.

If the user does not desire to connect with friends, the process moves to (94) where the user is provided the opportunity to review popular products. The popularity of the products may be based upon the quantity of user reviews, ratings associated with user reviews, recency of user interaction, merchant compensation, or any other desired metric. If the user desires to review popular products, the server (22) provides (96) the user with access to information regarding popular products. If the user does not wish to review popular products, the user may (98) search for particular products, categories, users or other information.

The system may either use a third party search engine or an internal search engine to allow the user to perform searches. If the user desires to perform a search, the user enters (100) the search criteria and a server (22) provides (102) the user with the results of the search. The user may use the results to do further research if desired. If the user does not wish to search content, the user may scan (104) a product (106). Preferably, the product is provided with a code (108). Alternatively, the user may scan (104) a virtual product. A virtual product may be a hard copy advertisement or a screen display of the product (106) or the code (108). The code (108) may be a UPC code, a QR code, an alphanumeric code, or any other desired code. If the user wishes to scan the product (106), the user uses the scanner (12) associated with the mobile device (10) to scan (104) the code (108). The mobile device (10) executes computer executable instructions to convert the scanned information to a digital code. Once the code (108) is scanned (104), the mobile device (10) sends (110) an information request regarding the product (106) to the server (22) across the network (14). The server (22) obtains the information regarding the product and sends (112) the requested information via the network (14) to the mobile device (10) that receives (114) the product information.

If the user does not wish to scan the product, the system allows the user to add (116) content, such as reviews, photographs, comments, etc., to the system. If the user wishes to add content to the system, the user in Step (118), and as more fully explained below, uploads the desired content to the server (22), which stores the content in the appropriate database (24), (26) or (28). If the user does not wish to add content, the system allows the user to research (120) a product. If the user desires to research the product, the user uses (122) research tools, such as warranty information, specification information, advertising, cost information, maintenance information, etc. Using (122) the research tools causes the server (22) to upload the desired research that is received (124) by the user. The process then moves to Step 126 to determine if there are any additional user requests. If there are additional requests, the process returns to Step (86). If there are no more actions to be taken by the user, this routine finishes (128). While the foregoing are examples of various options associated with the system, the system may provide a user fewer or more options than those described above.

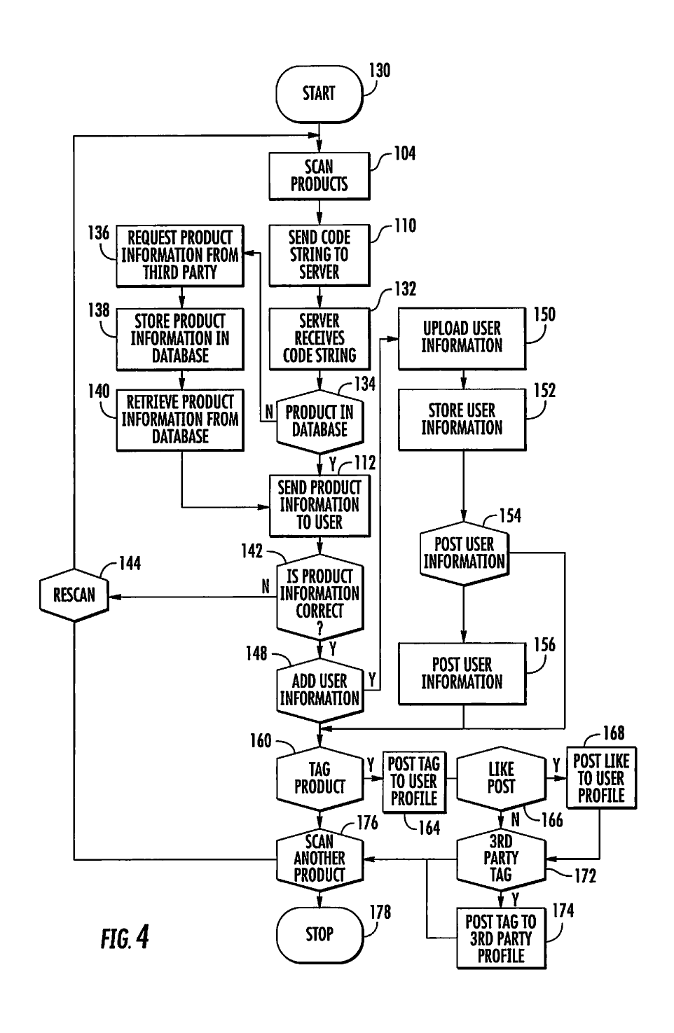

FIG. 4 is a flow diagram showing the steps typically performed by the system in Steps (104), (110), (112) and (114) of FIG. 3. The process starts (130) with the user scanning (104) the product code (108) associated with the product (106). Once the mobile device (10) has scanned the code (108), the mobile device (10) is provided with computer executable code that converts the scanned code (108) into a code string in a manner such as that known in the art. The mobile device (10) then sends (110) the code string to the server (22) via the network (14). The server (22) receives (132) the code string and uses the code string to determine (134) whether the product (106) associated with the code string is located in the database (24).

If the product is not in the database, the server (22) may use steps (74), (76) and (78) described above and shown in FIG. 2 to request (136) product information from a third party, such as a merchant's server (30), a search engine server (34) or a product information aggregation server (40). The system then stores (138) the product information in the product information database (24). If the product is not in the database, the server (22) may query other users about the product and/or compile information about the product submitted to the system by other users, and store this “crowd-sourced” information about the product in the product information database (24).

Once the product information is in the product information database (24), the system retrieves (140) the product information from the database and sends (112) the product information to the mobile device (10) via the network (14). The user then enters an input into the mobile device (10) indicating whether or not the product information is correct. If the product information is not correct, the user is provided the opportunity (142) to rescan (144) the product code (108). If the user does not wish to rescan the product code (108), the routine finishes at (146). If the user does wish to rescan the product code (108), the routine returns to Step (104) and repeats.

If the product information is correct, the user is provided with the option to annotate (148) the product information with additional data provided by the user. If the user wishes to add information to the product information, the user uploads (150) the user information and the information is sent to the server (22) via the network (14). The server (22) stores (152) the user information on one of the databases (24), (26) or (28) associated with the server (22) and, if desired, may (154) post (156) all or some of the information to the user's social media profile (158), timeline and/or activity feed. (FIGS. 1, 4 and 7). The user may “tag” (160) the product, by selecting the tag button (162) displayed on the graphical user interface (292) on the mobile device (10). (FIGS. 1, 4 and 7). In response, the mobile device (10) transmits to the server (22) that the user has selected the tag button and the server (22) posts (164) to the user's social media profile (158) a post indicating that the user has tagged the product. Once the server (22) has published the post, the user, and others authorized by the user may comment on and/or “like” the post. If other users like (166) the post, the server (22) publishes (168) an indication that the post has been liked.

As shown in FIG. 4, the users of the social media platform (170) may tag (172) the post, by selecting the tag button (162), thereby causing the server (22) to publish (174) a similar post on the other user's social media profile, timeline and/or activity feed. The social media profile (140) and other social media profiles may be associated with a social media platform (170) hosted on the server (22), or a social media platform to which the server (22) is provided access to publish content. In Step (176), the user is provided the opportunity to scan another product. If the user wishes to scan another product, the routine returns to Step (104) and repeats. If the user does not wish to scan another product, the routine finishes (178).

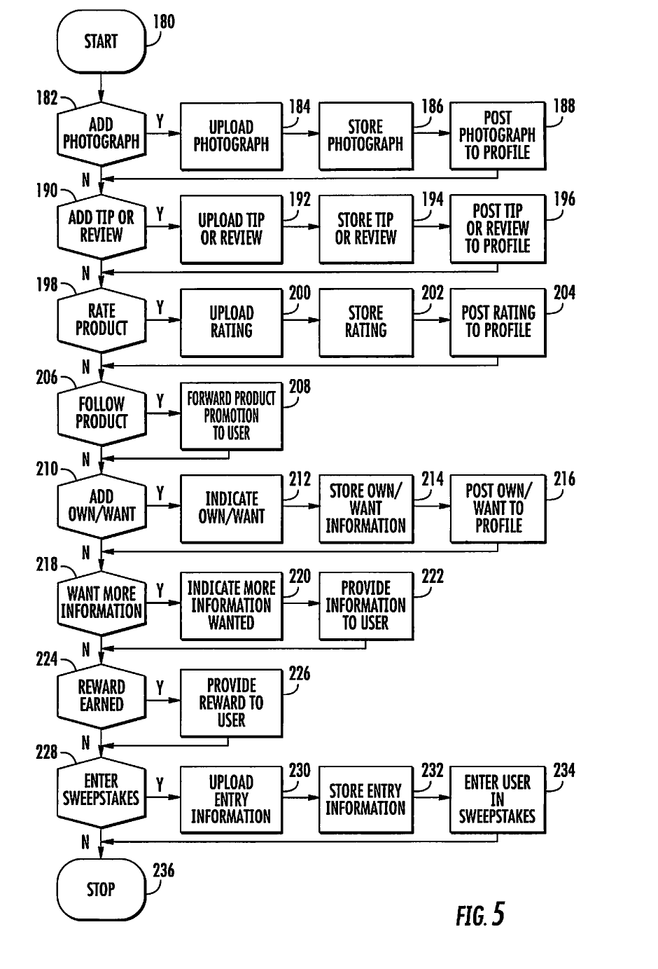

FIG. 5 is a flow diagram showing the steps typically performed by the system to allow the user to add content to product information as first described above in Step (118) associated with FIG. 3. The process starts (180) by determining (182) whether the user desires (182) to add a photograph. If the user desires to add a photograph, the user uses a computer, such as the mobile device (10), a laptop (46), tablet computer (48) or desktop computer (58) to upload (184) a photograph to the server (22) via the network (14). Once the photograph is uploaded to the server (22), the server (22) may store (186) the photograph in one of the databases (24), (26) or (28) and, if desired, the user may post (188) the photograph to the user's social media profile (158). (FIGS. 1, 5 and 7). The user may also add (190) a tip or review to the product information by uploading (192) the tip or review to the server (22) via a computer system (10), (46), (48) or (58). Once the server (22) receives the tip or review across the network (14), the server (22) may store (194) the tip or review in one of the databases (24), (26) or (28) and, if desired by the user, post (196) the tip or review to the user's social media profile (158), which the user and those designated by the user may annotate with comments.

If the user desires to rate (198) a product, the user may upload (200) a rating to the server (22) across the network (14) using a computer, (10), (46), (48) or (58). The rating may be a single designation, such as thumbs up or thumbs down, or may be a numeric or star rating such as those known in the art. Once the server (22) has stored (202) the rating information, the user may cause the server to post (204) the rating to the user's social medial profile (158).

If the user wishes to follow (206) a brand, such as a trademark, the user indicates the desire to follow (206) the brand by selecting a button on the mobile device (10) or otherwise indicating the desire to follow (206), which is received across the network (14) to the server (22). The server (22) associates the brand with an entity and information about the brand. The entity may be the corporate owner of the brand and the information may be an address, such as a physical address, an email address, a website, or phone number associated with the entity. The information may also be details about the brand, promotions, product specifications, new product information, or any other desired information. The server (22) may make this association through its own internal database of brands and owners, or via a third-party database.

After associating the brand with the owner of the brand, and information about the brand, the server (22) may forward (208) the information about the brand directly to the user, and/or forward information about the user to the owner of the brand. Information about the user may include products that the user has purchased, commented on, or requested information about. Information about the user may also include demographic information about the user. The server (22) may use the address to transmit the information about the user to the owner of the brand, or may provide the information, across the network (14), to a merchant server (30) associated with the owner of the brand. The server (22) may also receive information from the brand owner, such as promotions, product specifications, new product information, or any other desired information. The server (22) may also forward (208) this information received from the brand owner, or other sources to the user.

If the user desires, the user may indicate that the user wants (210) the particular product. If the user wishes to make such an indication, the user makes the indication by selecting (212) a “want” button on the mobile device (10), or providing the server (22) with some other predetermined indicator. The server (22) then stores (214) the information on a database (24), (26) or (28), and if the user desires, posts the information to the user's social media profile.

If the user desires, the user may indicate that the user wants (218) more information on the particular product. If the user wishes to make such an indication, the user makes the indication (220) by selecting a “want more information” button on the mobile device (10), or providing the server (22) with some other predetermined indicator. The server (22) then retrieves the information, either from the database (24), or an alternative source, and provides (222) the requested information to the mobile device (10) for display to the user.

The system may be designed such that if the user completes a number of designated tasks, purchases a certain number of particular products, or spends a certain dollar amount, the user may earn rewards, such as badges, points, coupons, discounts or other rewards known in the art. If the user has earned (224) a reward, the server (22) either provides (226) the reward directly to the user across the network (14) or provides the user with information regarding how to obtain the reward.

The system may also allow the user to enter (228) a sweepstakes. If the user wishes to enter (228) the sweepstakes, the user uploads (230) sweepstakes entry information through a computer (10), (46), (48) or (58) across the network (14) to the server (22). The server (22) stores (232) the entry information and then enters (234) the user into the sweepstakes and informs the user if the user wins the sweepstakes. If the user does not wish to perform any action, this routine finishes at (236).

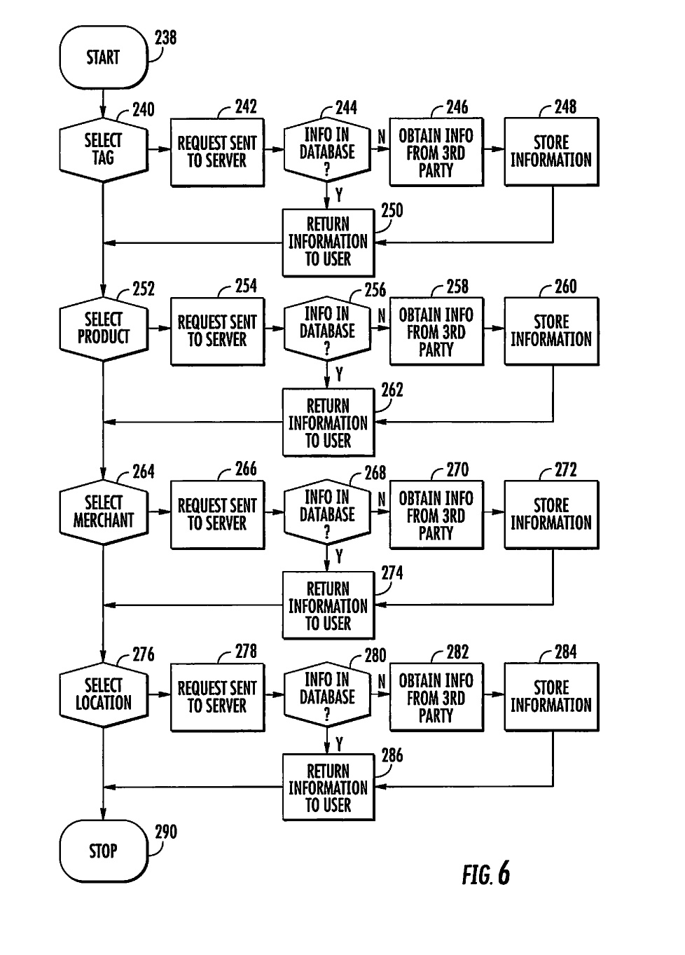

FIG. 6 is a flow diagram showing steps typically performed by the system in allowing a user to research a product as described above in Steps (122) and (124) associated with FIG. 3. As noted above, the system allows a user to research (122) the database (24) for additional product information. The user may search for product information by the generic product name, specific product name, brand name, or a description of the product. The system allows the user to search tags, product specifications, warranties, tips, reviews and/or comments stored on the database (24). The system also allows the user to search outside the database (24) to search publicly accessible third party databases and/or private databases to which the server (22) has been granted access.

The process starts (238) by determining (240) if the user wishes to search by a tag associated with a product. The tag may be a designation of a particular product category, a manufacturer, a retailer or any other desired category. If the user selects (240) the tag, by selecting a button or typing in the name of the tag to the computer (10), (46), (48) or (58), a request is sent (242) to the server (22) across the network (14). The server (22) determines (244) whether the information associated with the tag is located in a database (24), (26) or (28) associated with the server (22). If the information is not located within a database (24), (26) or (28) associated with the server (22), the server (22) obtains (246) the information from a third party, such as a merchant server (30), a search engine server (34), or a product information aggregator server (40) and stores (248) the information on a database (24), (26) or (28) associated with the server (22). Once the desired information is in the database (24), (26) or (28) associated with the server (22), the server (22) returns (250) the information to the user.

If the user desires to search by a particular product, the user can select (252) the product or type the name of the product into the system and the request is sent (254) to the server (22) across the network (14). The server (22) determines (256) whether the information regarding the product is located in the database (24), (26) or (28) associated with the server. If the information is not located in the database (24), (26) or (28), the server (22) obtains (258) the information from a third party server and stores (260) the information in a manner such as that described above. Once the information is in the database (24), (26) or (28) associated with the server (22), the server (22) returns (262) the information to the user.

If the user wishes to research information regarding a merchant, a user selects (264) a merchant either by selecting a button on the mobile device (10) indicating the merchant, or typing the merchant information into the computer (10), (46), (48) or (58). A request is thereafter sent (266) to the server (22). The server (22) determines (268) if the information is contained within the database (24), (26) or (28) associated with the server (22). If the information is not located within the database (24), (26) or (28) associated with the server (22), the server (22) obtains (270) the information from a third party and stores (272) the information in a manner such as that described above. Once the information is contained within a database (24), (26) or (28) associated with the server (22), the server (22) returns (274) the information to the user.

If the user wishes to research information regarding a location, such as the address of the nearest retailer offering a particular product for sale, the user selects (276) a location either by using the GPS or other location services associated with the mobile device (10) or by inputting the desired location information into the mobile device (10), or a computer (46), (48) or (58). A request is thereafter sent (278) to the server (22) across the network (14). The server (22) determines (280) if the information regarding the location is contained within a database (24), (26) or (28) associated with the server (22). If the information is not located within a database (24), (26) or (28) associated with the server (22), the server (22) obtains (282) the information from a third party in a manner such as that described above, and stores (284) the information within a database (24), (26) or (28) associated with the server (22). Once the information is located within a database (24), (26) or (28) associated with the server (22), the server (22) returns (286) the information to the user.

While in the preferred embodiment, the server (22) stores the tag, product, merchant and location information on a database (24), (26) or (28) associated with the server (22), the server (22) may provide the user with a hyperlink or uniform resource locator (URL) to the desired information contained on a third party server (30), (34) or (40). If the user does not wish to research any additional information, the routine finishes at (290).

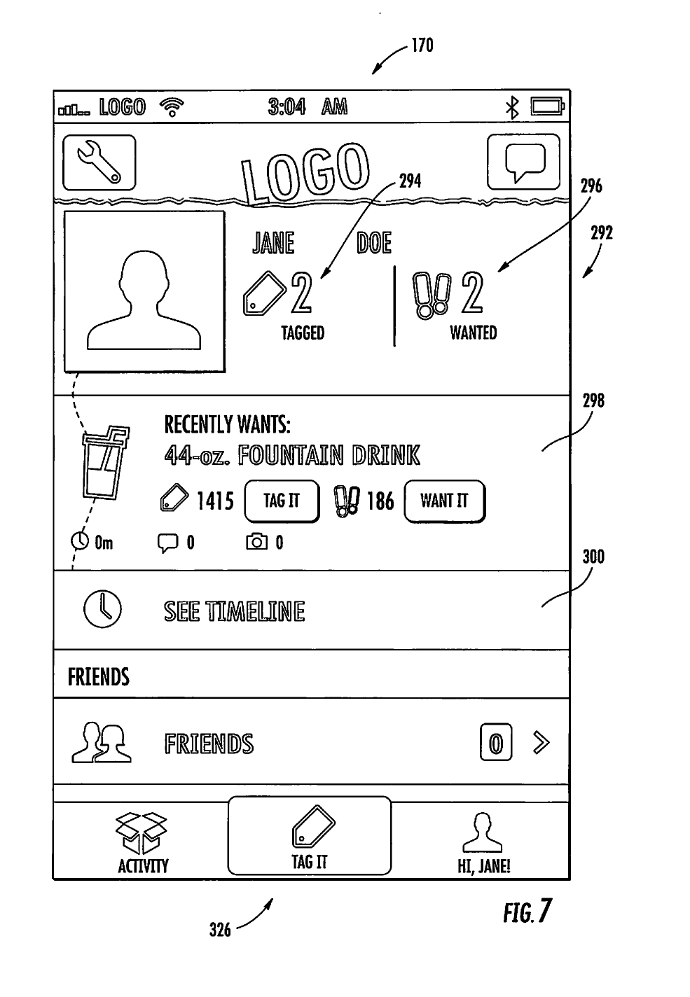

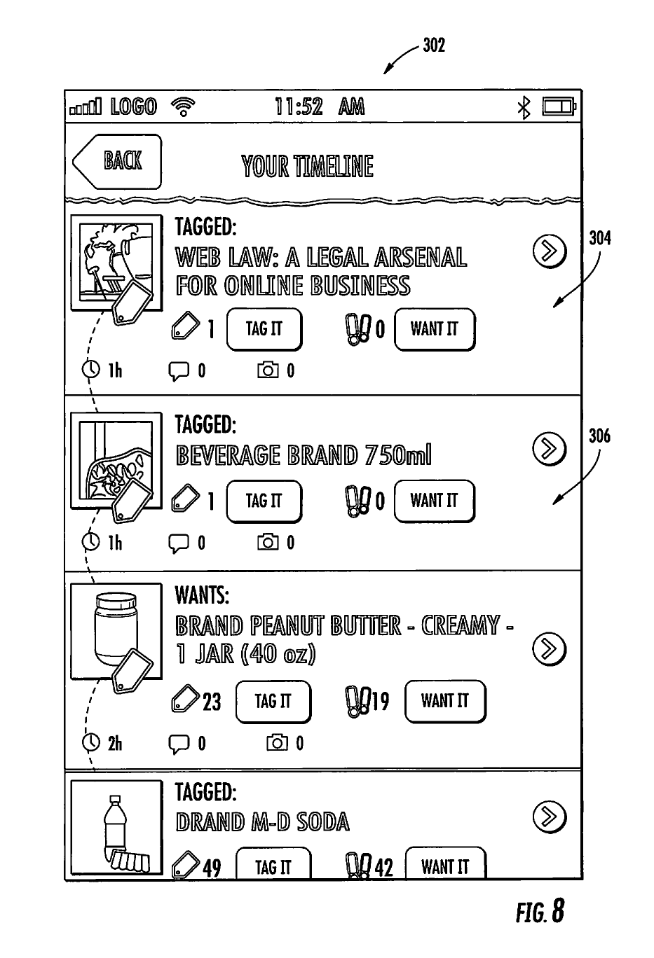

FIG. 7 is a display diagram showing the options available to a user through a user profile interface (292) associated with a social media platform (170) in accordance with one embodiment. The interface (292) displays a tag indicator (294), indicating how many products the user has tagged, and a wanted indicator (296), indicating how many products the user has indicated the user wants. The interface (292) also displays a recently purchased indicator (298), indicating the product most recently tagged by the user. A timeline button (300) is located on the interface (292). When selected by the user, the timeline button (300) displays a timeline screen (302) with the user's timeline (304). (FIGS. 7-8). The user's timeline (304) displays a plurality of product buttons (306) identifying, from top to bottom, in reverse chronological order, those products the user has recently tagged or indicated the user wanted.

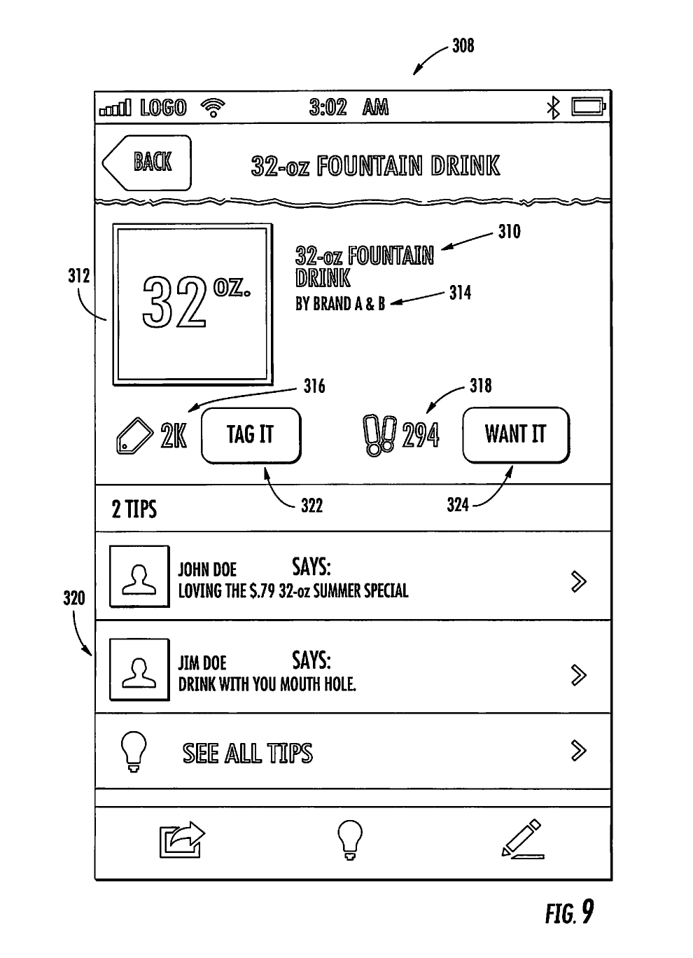

When selected, the product buttons (306) display a product screen (308) associated with the button (306). (FIGS. 8-9). The product screen (308) displays a description (310) of the product, a photograph (312), the name (314) of the product manufacturer or distributer, a tag indicator (316), indicating how many users have tagged the product, and a wanted indicator (318), indicating how many users have indicated they wanted the product. The product screen (308) displays tips (320) posted by users that relate to the product, a tag button (322) and a want button (324), allowing the user to tag or want the product right from the product screen (308). The product screen (308) also displays a tip button (326) and a review button (328). Selecting the tip button (326) pulls up a text box, into which the user may type a tip regarding the product, which is then associated with the product and available from the product screen (308). Selecting the review button (328) pulls up a text box, into which the user may type a review of the product, which is then associated with the product and available from the product screen (308).

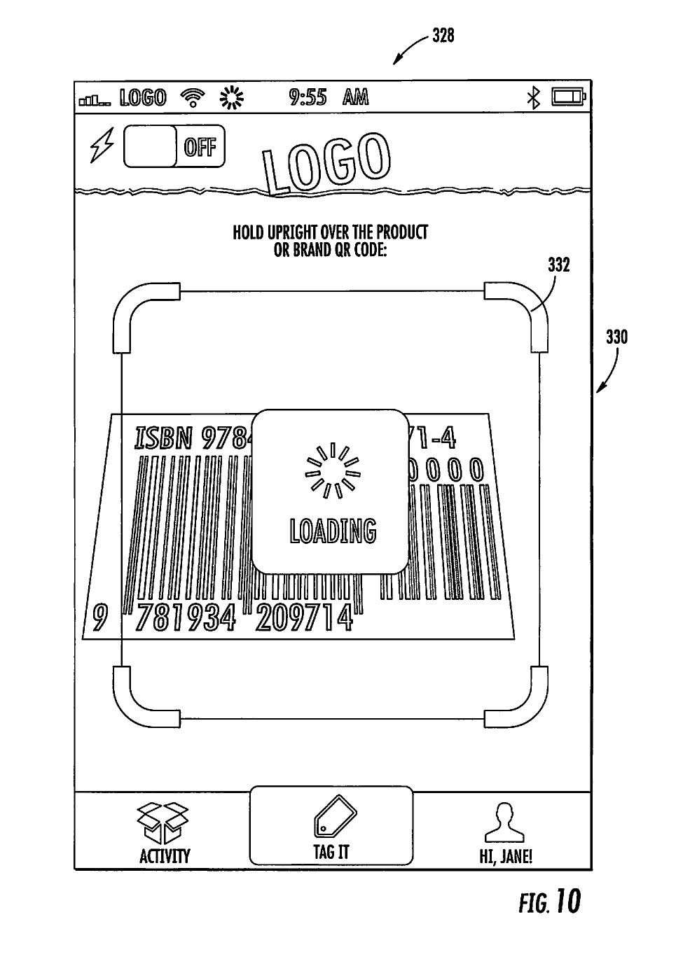

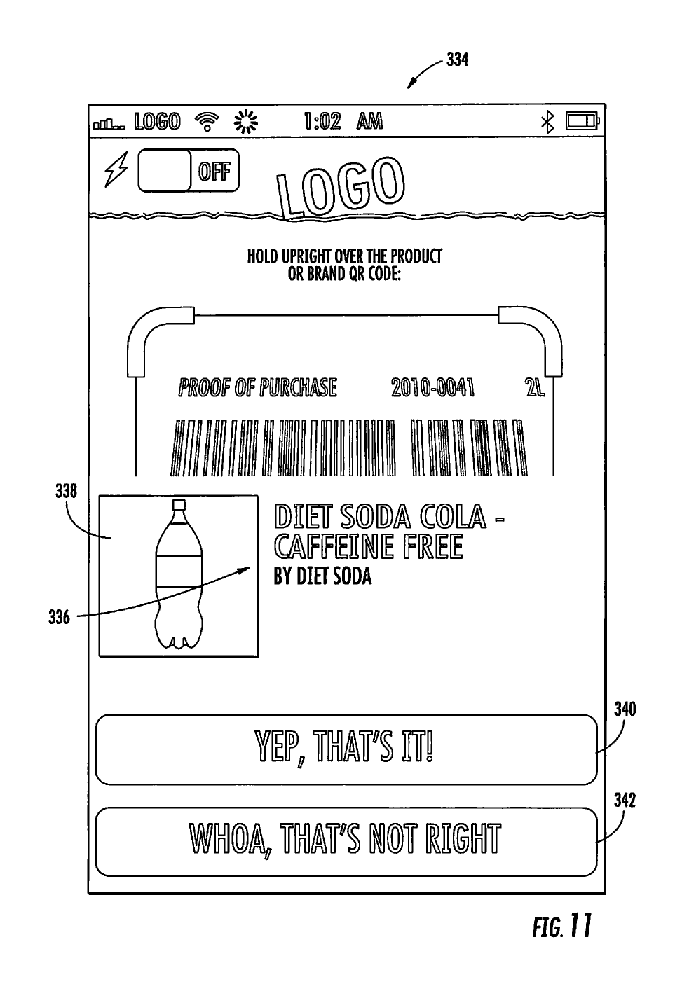

As shown in FIG. 7, the user profile interface (292) displays a tag it button (330). When selected, the tag it button (330) displays a scanning screen (332), having an active display (334) showing images camera integrated into the mobile device (10). (FIG. 10). A reticle (336) is preferably displayed on the scanning screen (332) to assist the user in properly aligning the code (108) of the product (106) within the active display (334). Once the code (108) is properly aligned, the mobile device (10) executes computer executable instructions to convert the scanned information to a digital code. Once the code (108) is scanned (104), the mobile device (10) sends an information request regarding the product (106) to the server (22) across the network (14). (FIGS. 1 and 3). The server (22) obtains the information regarding the product and sends (112) the requested information via the network (14) to the mobile device (10) that receives (114) the product information and displays a confirmation screen (338) with a description (340) of the product, a photograph (342) of the product, an accept button (344) and a refusal button (346). (FIGS. 1, 3, and 10-11).

Regardless of how a user enters information about a product into the system, whether by scanning the product or entering the product information directly into the system, or selecting the product from another user's profile, the user can receive information about the product from the server (22) in a manner such as that described above. This information may include, but is not limited to, warranty information, product instructions, specifications, websites, videos, images, customer service contact information, product ratings and reviews, merchant information, manufacturer information and price information.

From the confirmation screen (338), the user may select the refusal button (346), in which case, the mobile device (10) offers to rescan the product code (108). Once the user selects the accept button (344), the mobile device (10) displays an annotation screen (348), having a description text box (350), a camera button (352), a location text box (354), social media share buttons (356) and (358), and a tag it button (360). (FIGS. 1, and 11-12). Selecting the text box (350) brings up a keyboard and allows the user to input text (362) about the product. Selecting the camera button (352), displays the camera screen of the mobile device (10), and allows the user to take a photograph to include with the annotation. Selecting the location text box (354) causes the mobile device (10) to use a location application, such as a global positioning satellite system, associated with the mobile device (10) to provide a listing of nearby vendors, which the user can select to add to the annotation. Alternatively, the user may type in a location directly into the location text box (354).

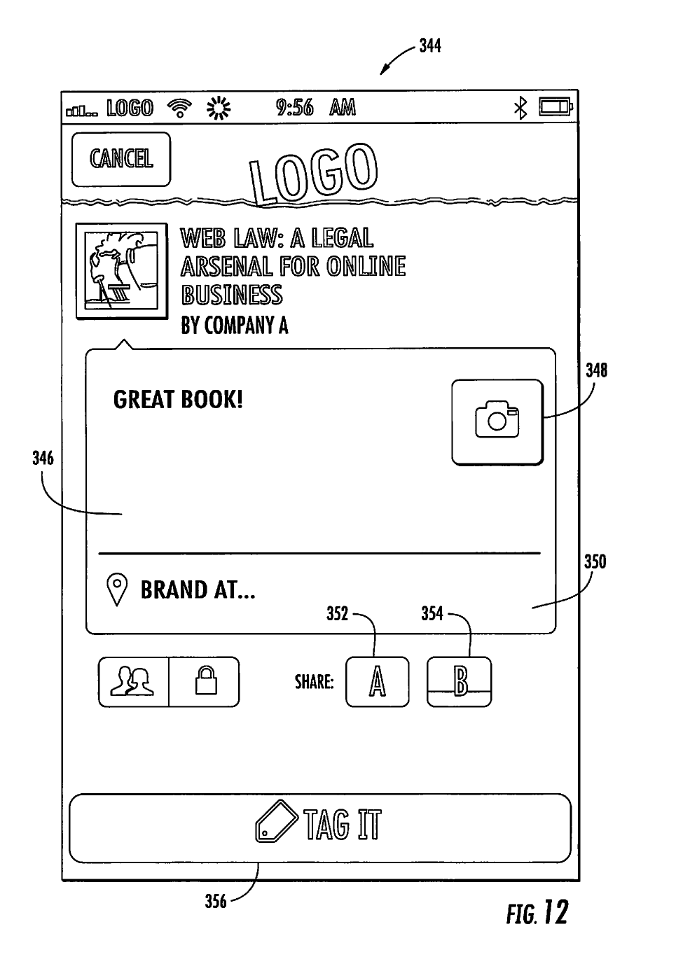

Selecting the social media share buttons (356) and (358) allows the user to share the annotation with social media platforms to which the social media platform (170) is authorized to post. Once the user has added all desired annotations into the annotation page (348), the user selects the tag it button (360), which causes the product information and annotations to appear in the user's timeline (304). (FIGS. 7 and 12).

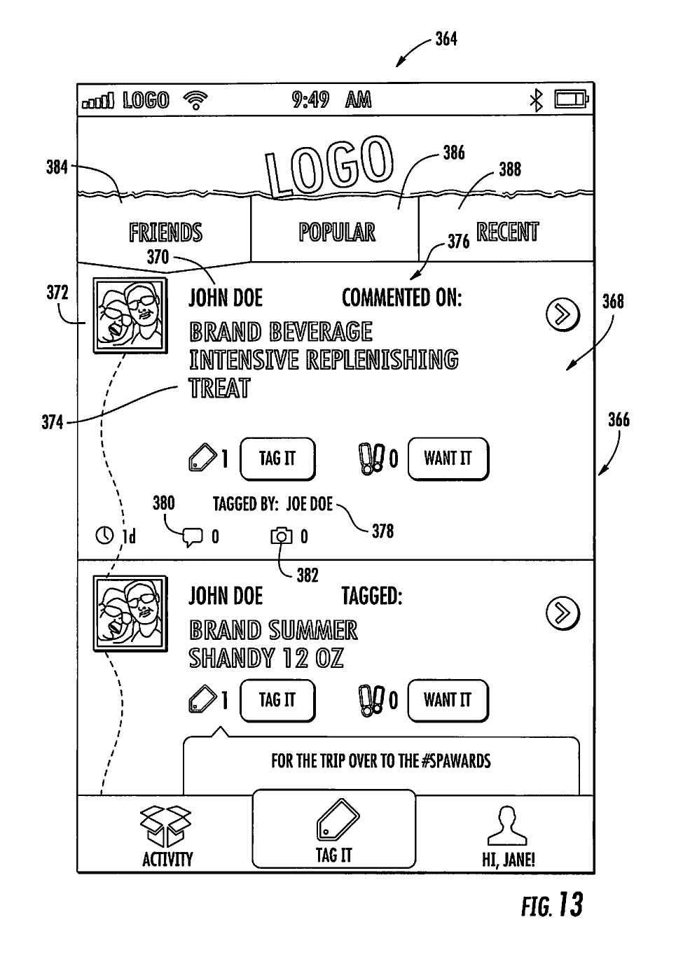

As shown in FIG. 7, the user profile interface (292) has an activity button (362) that, when selected, displays the last of three activity screens (364), (390), or (414), accessed by the user. (FIGS. 7 and 13-15). FIG. 13 shows a friends screen (364), having timeline (366) listing, from top to bottom, in reverse chronological order, activities of other users of the social media platform (170) between which the user and the other users have authorized, in a manner such as that known in the art, the sharing of information amongst themselves. Each listing (368) in the friends timeline (366) displays the name (370) of the friend, a photograph (372) or other avatar of the friend, the name (374) of the product, the activity (376) done by the other user in association with the product, the name (378) of the person who originally tagged the product, and buttons (380) and (382) to allow the user the add a comment or photograph.

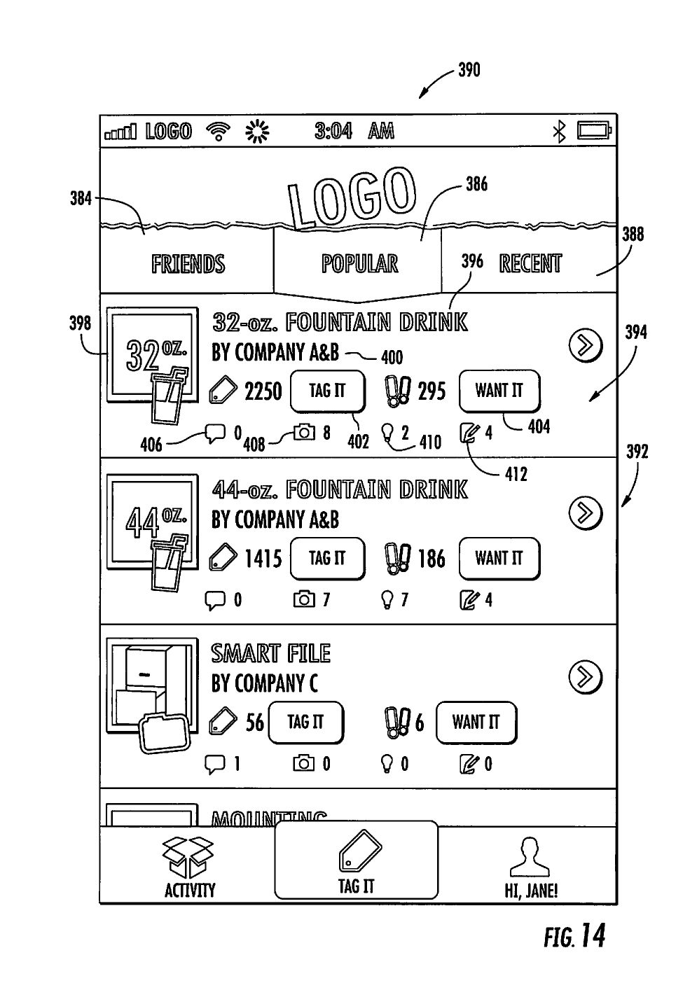

The friends screen (364) has three buttons (384), (386) and (388), to allow the user to switch between the activity screens (364), (390), or (414). Selecting the popular button (386) displays the popular screen (390), having a popular ranking (392) listing, from top to bottom, products having received the most activity on the social media platform (170). The activity may be weighted, and may include such things as product page views, tags, identification of wants, tips, reviews, comments, etc. input by users of the social media platform (170). (FIGS. 13-14). Each listing (394) in the popular ranking (392) displays the name (396) of the product, a photograph (398) of the product, the name (400) of the manufacturer or distributor, a tag indicator (402), indicating how whether the user has tagged the product and how many times the product has been tagged by users, and a wanted indicator (404), indicating whether the user has wanted the product and how many times the product has been identified as wanted by users. Each listing (394) also displays buttons (406), (408), (410), and (412), to allow the user to comment on, add a photograph of, add a tip to, or add a review to, the product.

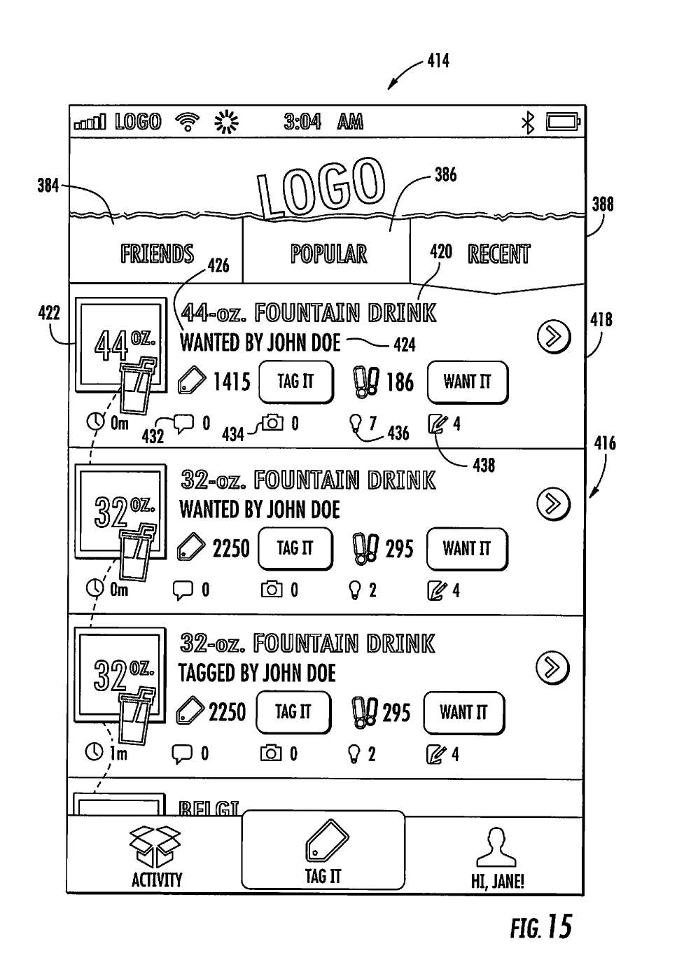

Selecting the recent button (388) from any of the three activities screens, displays the recent screen (414) having a recent timeline (416) listing, from top to bottom, in reverse chronological order, the products most recently tagged, listed as wanted, or otherwise annotated by users of the social media platform (170). (FIG. 15). Each listing (418) in the recent timeline (416) displays the name (420) of the product, a photograph (422) of the product, the name (424) of the person conducting the most recent activity, and the name (426) of the activity. Each listing (418) also includes a tag indicator (428), indicating whether the user has tagged the product and how many times the product has been tagged by users, and a wanted indicator (430), indicating whether the user has wanted the product and how many times the product has been identified as wanted by users, and buttons (432), (434), (436), and (438), to allow the user to comment on, add a photograph of, add a tip to, or add a review to, the product.

Although a few implementations have been described in detail above, other modifications are possible. Moreover, other mechanisms for presenting a user with product information may be used. In addition, the logic flows depicted in the figures do not require the particular order shown, or sequential order, to achieve desirable results. Other steps may be provided, or steps may be eliminated from the described flows, and other components may be added to or removed from the described systems. Accordingly, other implementations are within the full, intended scope of the following claims.

What is claimed is:

1. A computer implemented method for aggregating information associating a user with a product, the method comprising:
(a) scanning a product code with a mobile device;
(b) in response to the step of scanning, assembling a first data transmission comprising:
(i) a code associated with the product; and
(ii) a code associated with the user;
(c) transmitting the first data transmission to a server across a global communication network;
(d) receiving from the server, to the mobile device, across the global communication network, a second data transmission comprising information associated with the product;
(e) displaying on a screen associated with the mobile device, the information associated with the product;
(f) receiving from a user, through the mobile device, an input; and
(g) in response to the step of receiving the input, posting a message to a social network, the message comprising:
a. an identification of the product; and
b. an identification of the user.

2. The computer implemented method for aggregating information associating a user with a product of claim 1, wherein the second data transmission comprises routing information to a supplemental server, further comprising the steps of:
(a) receiving from the user, through the mobile device, a supplemental input; and
(b) in response to receiving the supplemental input from the user, interconnecting the mobile device with the supplemental server.

3. The computer implemented method for aggregating information associating a user with a product of claim 2, wherein the supplemental server is associated with a vendor of the product.

4. The computer implemented method for aggregating information associating a user with a product of claim 2, further comprising the step of displaying, on the mobile device, information from the supplemental server associated with the product.

5. The computer implemented method for aggregating information associating a user with a product of claim 4, wherein the supplemental server is associated with a vendor of the product.

6. The computer implemented method for aggregating information associating a user with a product of claim 4, wherein the information from the supplemental server is warranty information.

7. The computer implemented method for aggregating information associating a user with a product of claim 2, further comprising the step of associating a hyperlink with the message.

8. The computer implemented method for aggregating information associating a user with a product of claim 7, wherein the hyperlink is associated with the supplemental server.

9. The computer implemented method for aggregating information associating a user with a product of claim 1, further comprising the step of associating a hyperlink with the message.

10. The computer implemented method for aggregating information associating a user with a product of claim 9, wherein the hyperlink is associated with the server.

11. The computer implemented method for aggregating information associating a user with a product of claim 7, wherein the hyperlink is associated with the supplemental server.

12. The computer implemented method for aggregating information associating a user with a product of claim 7, wherein the hyperlink is associated with a vendor of the product.

13. The computer implemented method for aggregating information associating a user with a product of claim 1, further comprising the step of posting to the social network third-party comments to the message.

14. The computer implemented method for aggregating information associating a user with a product of claim 1, wherein the supplemental server is associated with a vendor of the product.

15. A computer implemented method for aggregating information associating a user with a product, the method comprising:
(a) scanning a product code with a mobile device;
(b) in response to the step of scanning, assembling a first data transmission comprising:
i. a code associated with the product; and
ii. a code associated with the user;
(c) transmitting the first data transmission to a first server across a global communication network;
(d) receiving from the first server, to the mobile device, across the global communication network, a second data transmission comprising information associated with the product;
(e) displaying on a screen associated with the mobile device, a plurality of options associated with the product;
(f) receiving from a user an option selected from the plurality of options;
(g) providing a second server;
(h) storing information associated with the product on the second server;
(i) in response to the step of receiving an option from the user:
(i) interconnecting the user with the second server; and
(ii) publishing a message to a social network, the message comprising:
a. an identification of the product; and
b. an identification of the user.

16. The computer implemented method for aggregating information associating a user with a product of claim 15, wherein the second data transmission comprises routing information to a supplemental server, further comprising the steps of:
(a) receiving from the user, through the mobile device, a supplemental input; and
(b) in response to receiving the supplemental input from the user, interconnecting the mobile device with the supplemental server.

17. The computer implemented method for aggregating information associating a user with a product of claim 16, wherein the supplemental server is associated with a vendor of the product.

18. The computer implemented method for aggregating information associating a user with a product of claim 16, further comprising the step of displaying, on the mobile device, information from the supplemental server associated with the product.

19. The computer implemented method for aggregating information associating a user with a product of claim 18, wherein the supplemental server is associated with a vendor of the product.

20. A computer implemented method for aggregating information associating a user with a product, the method comprising:
(a) providing a mobile device with a wireless connection to a global communication network;
(b) scanning a product code with the mobile device;
(c) in response to the step of scanning, assembling a first data transmission comprising:
i. a code associated with the product; and
ii. a code associated with the user;
(d) transmitting the first data transmission to a server across the global communication network;
(e) receiving from the server, to the mobile device, across the global communication network, a second data transmission comprising information associated with the product;
(f) displaying on a screen associated with the mobile device, a plurality of options associated with the product;
(g) receiving from a user, on the mobile device, an option selected from the plurality of options;
(h) in response to the step of receiving an option from the user, transmitting a third data transmission across the global communication network.

21. The computer implemented method for aggregating information associating a user with a product of claim 20, wherein the mobile device comprises a telephone.

22. The computer implemented method for aggregating information associating a user with a product of claim 20, further comprising storing information associating the user with the product on a database associated with the server.

23. The computer implemented method for aggregating information associating a user with a product of claim 22, further comprising;
(a) associating the product with the owner of a brand; and
(b) forwarding from the server to the owner of the brand, the information associating the user with the product.
